(19) United States
(12) Patent Application Publication
(10) Pub. No.: US 2002/0122547 A1
(43) Pub. Date: Sep. 5, 2002

(54) Method and apparatus for telephony route selection

(76) Inventors: Allan J. Hinchey, Kanata (CA); Douglas W. J. Zolmer, Nepean (CA)

Correspondence Address: Neil Mothew, Nortel Networks Limited, IPS Legal Department, P.O. Box 832130, Mail Stop 468/05/B10, Richardson, TX, 75083-2130, US

(21) Appl. No.: 09/746,103

(22) Filed: Dec. 21, 2000

(51) Int. Cl. H04M 7/00

(52) U.S. Cl. 379/221.01; 379/219

(57) ABSTRACT

A method and apparatus for providing access device input format independent translations and route selection for telephony calls. A call request is received, the call request comprising input information being for a telephony call. At least one call attributes is then determined from the input information and a routing policy request is transmitted to query a route database. Responsive to the routing policy request a routing policy response is received, the response comprising at least one routing parameter. The at least one routing parameter is used to influence call set up. Route selection is therefore not constrained by the service request input format.

### TECHNICAL FIELD

The invention relates to translating telephony calls. More particularly, this invention relates to route selection for telephony calls according to call attributes derived from a service request.

### BACKGROUND

In a prior art circuit switched telecommunication switching system comprising a plurality of switching nodes, each switching node requires predefined knowledge of the numbering plan of the telecommunication switching system and also of how the switching nodes are interconnected. An example of such a system is the public telephone network of the United States. Within the United States, the telephone numbers were grouped in terms of area codes; and within each area code, the telephone numbers were further grouped by the first three digits of the telephone number. This hierarchy of telephone numbers (also referred to as the numbering plan hierarchy) was modeled after the hierarchy of switching nodes, e.g. central and tandem offices. Within each central office, the routes to be utilized to reach area codes or other groups of telephone numbers was predefined at initialization or during system operation by the actions of a system administrator in configuring a translations database. “Translations” is a term used to refer to the process of interpreting call request information (dialed digits for example) received from an end user device or incoming trunk, determining the requested call type and associated called destination, and resolving this information to an internal reference which can be used by call processing to terminate calls to the appropriate service, end user device or outgoing trunk route.

Translations databases in circuit-switched telephony networks typically had been manually configured through static associations from originating-endpoints to routes based on a service request comprising dialed digits. The static associations had generated complex data models having a directed graph from each possible originating endpoint. This model has been in the form of a tree structure indexed by dialed telephony digits associated with each feasible route.

This complex data model is manually administered. With manual administration, a high cost is associated with maintaining and updating the data model. Furthermore, due to the human intervention required to reconfigure the translations and switching equipment when setting up or making any changes to network infrastructure, the update process becomes increasingly time consuming and error prone as the model size and complexity increases.

Emerging packet-based telephony communications technology, such as Voice over Internet Protocol (“VoIP”) does not limit the service request input format to dialed digits as found on a telephony keypad. Furthermore, whilst the most significant digits of the dialed number had previously been associated with a predetermined central office, this is no longer necessary since the network architecture is not hierarchical as with circuit-switched networks.

As the demand for telephony services grows, so does the requirement to allocate aliases for endpoints coupled to the network. With the redundancy of hierarchic and geographic restrictions on the allocation of aliases, increased flexibility in allocating aliases allows a more distributed usage of aliases. However, the trade-off with this increased flexibility is that the management and provision of the translations data to translations databases becomes increasingly complex and error-prone.

It would be desirable to provide a method and apparatus for translating a call to a called alias by deriving call attributes from a service request independent of the access device and request input format; and use the call attributes derived from the service request to translate the call to a destination or service associated with the called alias.

### SUMMARY

Provided is a method and apparatus for providing access device input format independent translations and route selection for telephony calls. A translations method and apparatus consistent with the present invention provides route selection of telephony calls unconstrained by access device input format.

An important aspect of translations in the telephony domain is the interpretation of an alias, the alias being associated with an endpoint on the communications network, and the selection of a route connecting a calling-party to a called-party's endpoint. As used here, an “alias” may be a telephony number, web page URL (Universal Resource Locator), e-mail address, common name, or any other unique identifier associated with the called party. The “alias” can use any combination of alphanumeric characters.

A call request is received, the call request comprising input information being for a telephony call. At least one call attribute is then determined from the input information and a routing policy request is transmitted to query a route database. Responsive to the routing policy request a routing policy response is received, the response comprising at least one routing parameter. The at least one routing parameter is used to influence call set up.

In some embodiments, a call server maintains a route database of the aliases associated with its supported endpoints and services. The call attributes determine the routing policy used to query the translations database of the ingress call server to select appropriate routes satisfying the call attributes. In some embodiments, the database may provide a preferred routing based on the call attributes and routing policy being applied.

In some embodiments, if the query to the ingress call server's translations database does not yield a routing result, then a second query may be performed to a route database to determine the appropriate call server that supports the called endpoint, service or trunk endpoint that can route towards the called destination. In a network with a plurality of call servers, each call server has responsibility to host pre-defined endpoints (terminals and/or trunks) and services. Such call server to endpoint and service associations may be statically or dynamically provisioned. Signaling between call servers may transfer the call handling from an ingress call server to an egress call server.

In some embodiments, a network management system (NMS) may be responsible for configuring each call server in the network with data for each endpoint and service hosted by the call server, including associated translations data. In some embodiments, a network translations route database is provided to support inter call server translations. If a translations request cannot be resolved within the local translations database of the ingress call server, a query is made to the network translations route database. The network translations route database is responsible for returning a reference to the call server hosting the called endpoint, service or trunk endpoint that can route towards the called destination.

An advantage of the invention is that route selection is made using call attributes rather than dialed digits, thus route selection is unconstrained by the request format of the access device. In communications networks, and more particularly data networks, terminals are not restricted to a twelve button keypad used to dial digits, but other more elaborate forms of input may be used to express a service request and called party alias/address information, for example, an alphanumeric address, an email address or a URL.

A further advantage of this invention is that it provides the ability to analyze any form of user input representing the service request and interpret it in terms of generic call attributes to select an appropriate route. The call attributes and translations route selection policies can therefore be reused in a manner independent of the input alias.

Further features of the invention, as well as the structure and operation of various embodiments of the invention, are described in detail below with reference to the accompanying drawings. The drawing in which an element first appears is indicated by the digit(s) to the left of the two rightmost digits in the corresponding reference number.

### BRIEF DESCRIPTION OF THE DRAWINGS

The invention will best be understood by reference to the following detailed description when read in conjunction with the accompanied drawings, wherein:

FIG. 1 is a block diagram of an exemplary IP network topology;

FIG. 2 is a diagram of international public telecommunications number structure for geographic areas under the ITU-T E. 164 Recommendation;

FIG. 3 is a diagram of a network translations subsystem to resolve called alias information to one or more terminating endpoints associated with the alias;

FIG. 4 is a diagram of a number route database;

FIGS. 5A, 5B and 5C is a flow chart for mapping called numbers according to a numbering plan and number range;

FIG. 6 is a flowchart for a call server handling a call;

FIG. 7 is a front view of a board carrier;

FIG. 8 is a rear view of a board carrier;

FIG. 9 is a computer system programmed for executing a computer program according to various embodiments of the invention.

### DETAILED DESCRIPTION

In the following description, numerous details are set forth to provide an understanding of the present invention. However, it will be understood by those skilled in the art that the present invention may be practiced without these details and that numerous variations or modifications from the described embodiments may be possible. For example, although the description refers to telephony communications over data networks, certain aspects of the methods and apparatus described may be advantageously used with other types of communications systems, such as those used on circuit switched networks.

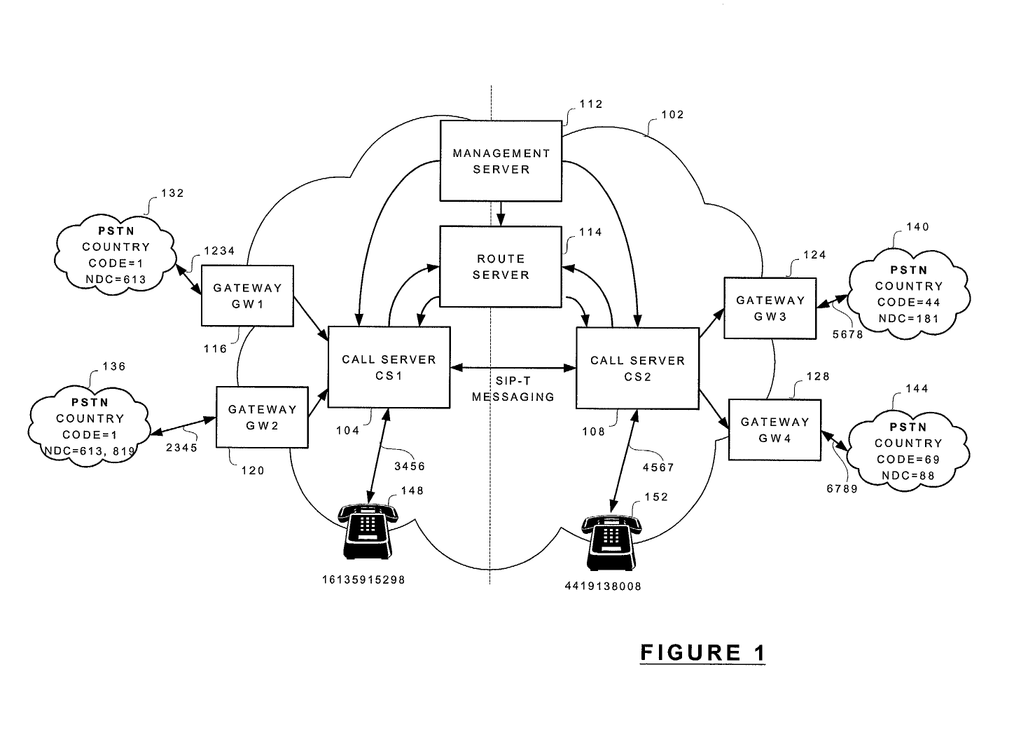

FIG. 1 is a block diagram of an Internet Protocol (“IP”) network topology. The communications network 102 is coupled to associated endpoints 116, 120, 124, 128, 148 and 152. As shown, the endpoints can be provided as communications gateways 116, 120, 124 and 128, and with terminals 148 and 152.

It should be appreciated that many more endpoints may be connected to communications network 102; and these are shown merely as examples.

Communications network 102 in this example may be a packet-based or message-based network. In one embodiment, the communications network 102 communicates according to the Internet Protocol (IP), which is one of the protocols on which the Internet is based, as described in Internet Engineering Task Force (IETF) Request for Comment 791, entitled “Internet Protocol,” dated September 1981. Communications network 102 provides quality of service to voice calls sufficient to provide adequate bandwidth and low latency.

A suitable communications network 102 has a single network or link, which can be coupled through gateways, routers, and the like. It should be appreciated by those skilled in the art that further complex architectures could be implemented with multiple networks or links. Further, it should be noted that communications network 102 could have geographically dispersed linked-data networks in business environments. Examples of such data networks are Local Area Networks (LANs).

As shown in FIG. 1, communications networks 132, 136, 140 and 144 are coupled to communications network 102 via communications gateways 116, 120, 124 and 128 respectively, to provide the communications interface between the networks.

Examples of suitable communications networks 132, 136, 140 and 144 are a public switch telephone network (“PSTN”), a private branch exchange (“PBX”), a local area network (“LAN”), a metropolitan area network (“MAN”), a wide-area network (“WAN”), a private network such as an Intranet, and public network such as the Internet. The underlying unifying factor of these networks is the ability to share data information under a common communications protocol, such as TCP/IP. Additional communications protocols can be implemented and data may be communicated between communications protocols using adequate conversion techniques.

Terminals 148 and 152 are capable of performing voice and other multi-media communications over a packet-based or message-based data network. As used herein, a terminal may be a computer-based system having speech capability, or may be telephony units having interfaces to the communications network. Accordingly, terminals 148 and 152 may be Internet Protocol (IP) telephones, each with an associated IP address; the IP address of each terminal having an associated phone number according to the E.164 standard. The aforesaid IP address may be dynamically or statically allocated. Dynamic allocation of the IP address can be performed using Dynamic Host Configuration Protocol; an existing IETF protocol that allows a server to assign IP addresses dynamically to endpoints as they connect to the network.

As shown in FIG. 1, call servers 104 and 108 are coupled to the communications network 102. The call servers act to manage telephony communications (for example, call setup, processing, and termination) between or among the endpoints. A suitable call server is available under the Succession™ Internet Product Portfolio from Nortel Networks, Ltd., of Brampton, Ontario, Canada. A call server builds a composite view of the translations data for all its endpoints in a local translations database. A function that the call servers provide is in the called alias translation to allow the call to progress throughout the network to its destination endpoint(s). As used here, an “alias” may be a telephony number, web page URL (Universal Resource Locator), e-mail address, common name, or any other unique identifier associated with the called party. The “alias” can use any combination of alphanumeric characters.

A route database 114, accessible by the call servers 104 and 108 through the communications network 102, provides support to inter-call server translations. Thus, if a called address translation request cannot be resolved within the ingress call server local translations database, a query may be made to route database 114. The network translations database in the route database 114 returns a reference to the call server hosting the terminating endpoint. The ingress call server may then use Session Initiation Protocol for Telephony (SIP-T,) messaging or an equivalent to forward the call signaling to the terminating call server. SIP-T is an emerging ITU messaging protocol standard for communicating between call servers. The terminating call server may then use its local translations database to locate the terminating endpoint and complete the call.

Additionally, management server 112 may be coupled to the communications network 102 for the management of selected resources coupled to communications network 102. Management server 112 may send the configuration data for each call server's hosted endpoints to the respective call server. From this configuration data, the respective call server may build run-time configuration data and a local translations database for the hosted endpoints. Endpoint configuration data may be provisioned through a management server and stored in a route database.

Although only one route database 114, management server 112 is illustrated, it should be appreciated that multiple route databases, management servers and call servers can be coupled to the communications network, as well as additional network resources, sufficient to handle the call traffic. In a multiple server configuration, the multiple call servers may be responsible for managing call requests from a group of terminals, and the route database may be responsible for serving a predetermined set of call servers. A call server, route database, and management server may be implemented on separate platforms or in a platform including some or all of the aforementioned components.

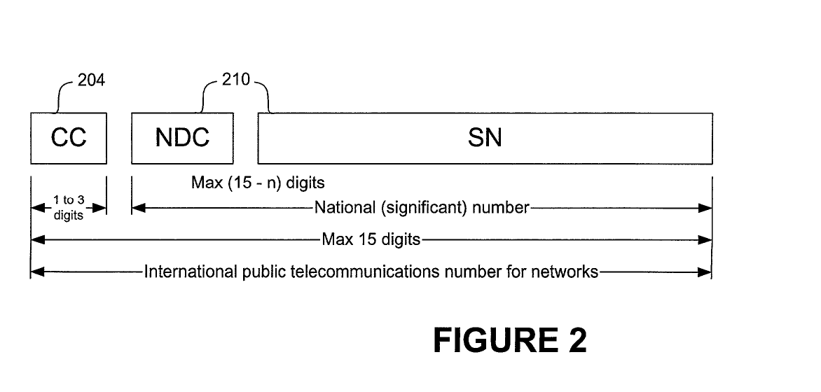

FIG. 2 is a diagram of international public telecommunications number structure for geographic areas under the ITU-T E. 164 Recommendation, titled “The international public telecommunication numbering plan”, dated May 1997, which is hereby incorporated by reference. This recommendation details the components of the numbering structure and the digit analysis required to successfully route calls in international public telecommunication networks.

The international public telecommunication number for geographic areas is composed of a variable number of decimal digits arranged in specific code fields. The international public telecommunication number code fields are the Country Code (CC) 204 and the National (Significant) Number, 210. The National (Significant) Number 210 may be (15-n) characters in length, where n is the number of digits in the country code (1 to 3 digits).

As used in the E.164 description, a public number is a string of decimal digits that uniquely indicates the public network termination point. The number contains the information necessary to route the call over a public network to this termination point; and this number is herein forth referred to as a “fully qualified” number. A public number can be in a format determined nationally or in an international format. The international format is known as the International Public Telecommunication Number, which includes the country code and subsequent digits, but not the international prefix.

As used also in the E.164 description, a numbering plan specifies the format and structure of the numbers used within that plan. It typically comprises decimal digits segmented into groups in order to identify specific elements used for identification (or aliasing), translations and charging capabilities, e.g. within E.164 to identify countries, national destinations and subscribers. A numbering plan does not include prefixes, suffixes, and additional information required to complete a call (these are components of dial plans). A national numbering plan is a national implementation of the E.164 numbering plan.

Such an example of a national numbering plan is the North American Numbering Plan (NANP). According to the NANP, the termination point has a number in the NXX-NXX-XXXX format, where N represents a digit from 2-9 and X represents a digit from 0-9. The first group of three digits indicates the area code or Number Plan Area (NPA) of the subscriber, the second group of three digits and the last four digits comprise the Station Number and indicate the address of the subscriber within the NPA. Digits 0 and 1 are of course not available as the first digit (N) allowing them to be used as dial plan prefixes for operator and long distance services.

In an enterprise telecommunications system, a private numbering plan is used. A private number is a string of decimal digits that uniquely indicates the private network termination point. Similar to a public number, the number contains the information necessary to route the call over a enterprise network to this termination point; and this number is herein forth referred to as a “fully qualified” number. A private numbering plan is in a format determined by the enterprise. Like a public numbering plan, a private numbering plan does not include prefixes, suffixes, and additional information required to complete a call (these are components of private dial plans).

Dial plans define the method by which number plans are used in terms of combinations of decimal digits dialed to place a call. Dial plans define the meaning of prefix and suffix digits, abbreviated called number formats and any other information, supplemental to the number plan, required to complete a call.

Public dial plans are defined at the national or regional level. Such an example of a dial plan is the one typically used in most areas of North America which defines 1 as prefix for long distance calls, 0 as a prefix for operator calls and allows for local calls to be dialed with a 7 digit abbreviated format of the 10 digit national number.

In an enterprise telecommunications system, private dial plans define the combinations of digits that may be used to provide the subscriber with different enterprise telecommunications services. These dial plans may service predetermined combinations of dialed digits and translate them to the various different telecommunications services. For example, a user may dial the digit ‘9’ as a prefix to a direct-outward-dialed (DOD) number to make a call from the enterprise network to a subscriber in the Public Switched Telephone Network (PSTN); and a user may dial the digit ‘6’ to prefix a private enterprise number to make a call to another party on the enterprise network. As used here, an “enterprise network” is a private communications system linking up enterprise communications equipment and endpoints. Examples of private and public telecommunications call types are listed in Table 1 below. Examples of dialing plan digit patterns for each of the enterprise call types are listed in Table 2 below, whilst examples of dialing plan digit patterns for DOD public call types are listed in Table 3 below. It should be apparent to a person of ordinary skill in the art that further examples may be added to these.

Call types are represented in Table 1 below.

TABLE 1

| Call Type Reference | Call Type |
|---|---|
| AA | Attendant Assisted |
| DA | Directory Assistance |
| DD | Direct Dial |
| DOD | Direct Outward Dial |
| ES | Emergency Service |
| INTER_SITE | Inter-Site |
| INTRA_SITE | Intra-Site |
| OA | Operator Assisted |
| VSC | Vertical Service Code |

Enterprise (Private) Dialing Plans are represented in TABLE 2 below.

TABLE 2

| Case | Call Type | | Private Call | Example of |
|---|---|---|---|---|
| Number | Description | Dialing Plan Schema | Type | Plan |
| 1 | Intra-site call | EXTN (extension) | INTRA_SITE | 54000 |
| 2 | Inter-site call | INTERSITE_PREFIX + | INTER_SITE | 6 + 395 + |
| | | LOCATION_CODE + EXTN | | 54000 |
| 3 | Enterprise | ATTENDANT_CODE | AA | 0 |
| | Attendant Call | | | |
| 4 | Enterprise | EMERGENCY_SERVICE_CODE | ES | 911 |
| | Emergency | | | |
| | Call | | | |
| 5 | Direct- | DOD_PREFIX + | DOD | 9 + 765-4000 |
| | outward-dialed | PUBLIC_DIALING_PATTERN | | 9 + 1 + 613 + |
| | public call | | | 765 + 4000 |
| 6 | Vertical | VERTICAL_SERVICE_CODE | VSC | *72, *1172 |
| | Service Code | | | *831, *11831 |
| | call | | | |

Direct Outward Dialed access to a Public Dialing Plan is represented in TABLE 3 below.

TABLE 3

| | | | Public | |
|---|---|---|---|---|
| Case | Call Type | | Call Type | Example (North |
| Number | Description | Dialing Plan Schema | Attribute | America) |
| 7 | Direct- outward-dialed | DOD_PREFIX + SN | DD | 9 + 745-1576 |
| | local call | | | |
| 8 | Direct-outward-dialed | DOD_PREFIX + | DD | 9 + 1 + 613 + 745- |
| | national call | NATL_LD_PREFIX + NDC + SN | | 1576 |
| 9 | Direct-outward-dialed | DOD_PREFIX + | DD | 9 + 011 + 44 + 207 |
| | international call | INTL_LD_PREFIX + CC + | | + 225-0603 |
| | | NDC + SN | | |
| 10 | Direct-outward-dialed | DOD_PREFIX + | OA | 9 + 0 + 613 + 745- |
| | operator assisted | LOCAL_OA_PREFIX + | | 1576 |
| | national call | NDC + SN | | |
| 11 | Direct-outward-dialed | DOD_PREFIX + | OA | 9 + 01 + 44 + 207 + |
| | operator assisted | INTL_OA_PREFIX + CC + NDC + | | 225-0603 |
| | international call | SN | | |
| 12 | Direct-outward-dialed | DOD_PREFIX + | OA | 9 + 0 |
| | attendant call | LOCAL_OA_CODE | | |
| 13 | Direct-outward-dialed | DOD_PREFIX + | ES | 9 + 911 |
| | emergency call | EMERGENCY_SERVICE_CODE | | |
| 14 | Direct-outward-dialed | DOD_PREFIX + | DA | 9 + 411 |
| | directory assistance | DIRECTORY_ASSISTANCE_{—} | | |
| | call | CODE | | |
| 15 | Direct-outward-dialed | DOD_PREFIX + | DD | 9 + 1 + |
| | national service call | NATIONAL_SERVICE_CODE | | 800/888/877/866/90 |

Call attributes may be derived by analysis of the dialed digits according to the dial plan in effect. One or more call attributes may be set as a result of the analysis. Table 4 below lists the call attributes and their possible values.

Call Attributes are represented in TABLE 4 below.

TABLE 4

| Call Attribute | Value |
|---|---|
| PRIVATE CALL TYPE | NONE, DOD, AA, ES, INTRA_SITE, |
| | INTER_SITE, VSC |
| PUBLIC CALL TYPE | NONE, DD, OA, DA, ES, VSC |
| EQUAL ACCESS TYPE | NONE, PREF, CAC |
| ORIGINATING | PRIVATE, PUBLIC |
| ENVIRONMENT | |
| PUBLIC CALL REACH | UNKNOWN, NATL, INTL |
| LOCAL CALL | BOOL |
| INDICATOR | |
| PUBLIC LATA TYPE | NOTAPPLICABLE, INTRA_LATA |
| | INTER_LATA |
| PUBLIC CARRIER ID | VALUE (range: 0 to 9999) |
| NATIONAL SERVICE | NONE, FREEPHONE, PAY_PER_CALL |
| TYPE CODE | |
| FULLY QUALIFIED | STRING |
| ALIAS | Example for telephony numbers: |
| | Numbering Plan ID: E.164 or private ID |
| | Number: fully qualified E.164 or private |
| | number |

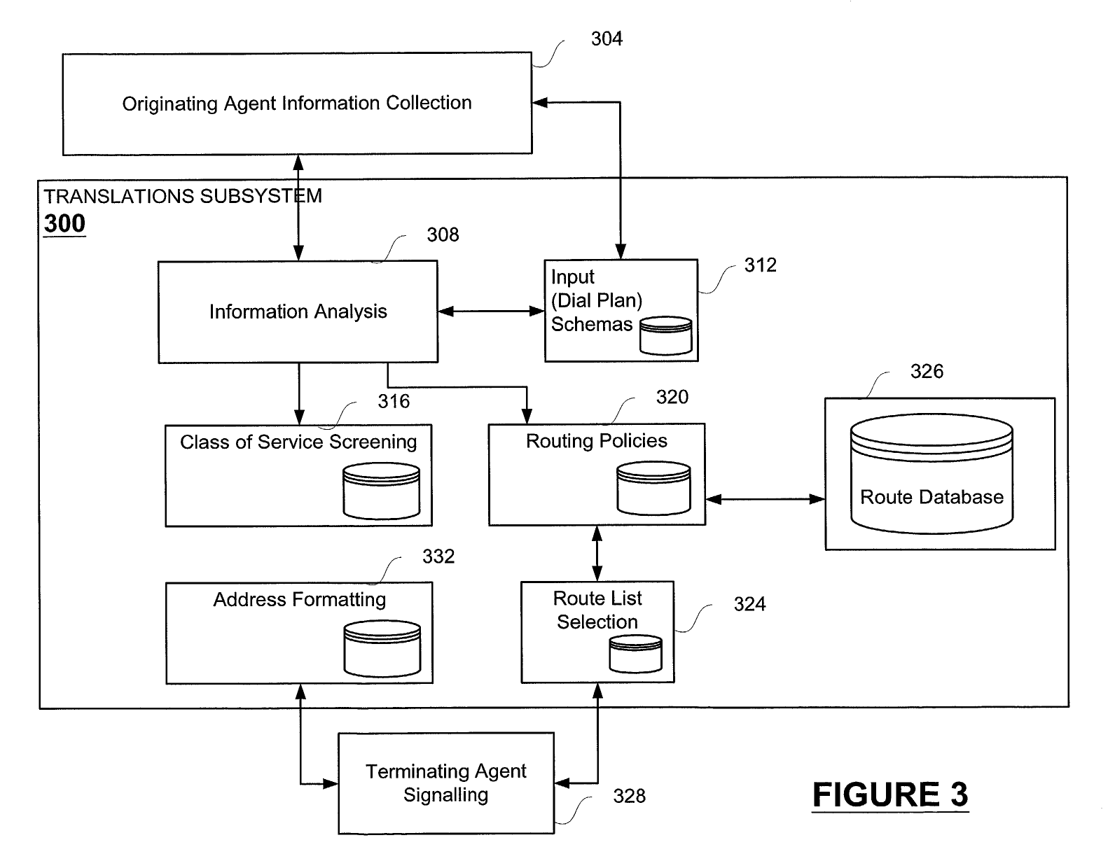

A high-level block diagram of the network translations subsystem to resolve called alias information to one or more terminating endpoints associated with the alias is provided in FIG. 3. Arrows between the blocks indicate the general flow of execution. The functions provided by the translations subsystem 300 are organized into subcomponents. A subcomponent function may be implemented using software executing on a computer platform or using logic circuitry deploying microcontroller or microcomputer circuitry. As used here, a “microcontroller” is generally a one-chip integrated system meant to be embedded in a single application; so it is likely to include all the peripheral features-program and data memory, ports, and related subsystems-needed for the computer aspect of the application. Also as used here, “microcomputer” circuitry drives a general-purpose computer whose ultimate application is not known to the system designers.

Network translations subsystem 300 may be hosted in a network resource such as call servers 104 and 108 of FIG. 1. The network translations subsystem 300 comprises subcomponents 308, 312, 316, 320, 324 and 332, which implement translations analysis and route selection logic and subcomponent 326, the route database, which contains the network routing data. The route database 326 can reside with the routing policies subcomponent 320 hosted on a network resource such as call servers 104 and 108 of FIG. 1, or can be hosted on a network resource such as route database 114 of FIG. 1, or can be a combination of both with a local route database containing routing information for endpoints hosted by the call server and a network route database containing routing information for endpoints hosted by all other call servers in the network.

The network translations route database subcomponent 326 may be provisioned with route characteristics describing the numbers, call-types, and service providers that the served endpoint may route to. The aggregate network route database (all network route data with reference to the constituent data contained in the local and network route databases) can be generated through a computer-implemented process based on individual endpoint route characteristics, without requiring manual intervention by a network administrator.

Call originations may be characterized in terms of call attributes such as called alias or number, call type (direct dialed, operator assisted, emergency, etc.) and service provider id. These attributes correspond to the route characteristics that may be provisioned against endpoints. Policies in the routing policies subcomponent 320 may use the call attributes to select appropriate routes from the aggregate network route database 326.

An originating agent information collection subcomponent 304 is communicatively coupled to the translations component 300. As used here, “communicatively coupled” refers to the coupling of a plurality of functional modules or subcomponents such that signals may be passed from one functional module to another functional module. The originating agent information collection subcomponent is responsible for collecting information signaled from an endpoint on behalf of an end user of the system and presenting this information to the translations subsystem.

The input schema subcomponent 312 contains a database of input schemas. A dial plan is an example of an input schema that outlines rules for interpreting a called alias or service code in the form of dialed digits. The dial plan schema may also comprise transformation rules for manipulating dialed digits of the called alias into a fully qualified directory number (such as an E.164 number) by removing prefix digits and access codes, and expanding abbreviated numbers with national destination, country and/or private location codes as needed. Input schema subcomponent 312 is communicatively coupled to information analysis subcomponent 308 and to originating agent information collection subcomponent 304. Schemas are defined by a management server 112 (see FIG. 1), and contain information defining the digit patterns that are valid within the dial plan and the interpretation of those digit patterns (what Call Attributes to set for a given pattern). The input schema subcomponent 312 provides an interface to retrieve the digit patterns, used by certain originating agent information collection implementations (such as media gateway control protocol based agents) to drive digit collection, typically during a Collect Information Point-In-Call (“PIC”). The input schema subcomponent 312 is also used in conjunction with the information analysis subcomponent 308 to analyze collected digits to determine the intent of the call (what Call Attributes to set).

The information analysis subcomponent 308 analyzes the collected information and defines the intent of the call using a predefined internal format comprising call attributes. In the case of dialed digits, this involves the use of a dial plan schema to determine the meaning of any prefix digits/access codes and set the appropriate call attributes, in addition to creating a fully qualified called number if applicable to the call type (Certain call types such as directory assistance do not include called number information in the dialed digits. These call types route to a service rather than to a specific called number.). This function is typically invoked during the collect information point in call, either once after receiving complete user input (dialed digits) en bloc or multiple times when receiving partial user input to determine if further information needs to be collected. Note that certain agent types, which receive user input signaled with an intelligent protocol such as ITU-T recommendation, H.323 may be able to bypass information analysis and initialize the call attributes directly based on the signaled data.

The routing policies subcomponent 320 is invoked during the Analyze Information point in call. Routing policies 320 employs a policy-based system to determine the route (or action) that should be taken, given the set of call attribute values produced during the Collect Information PIC. Routing policies can be predefined and/or customer provisioned using a management server 112 (see FIG. 1). This subcomponent is communicatively coupled to the route database 326, which may be implemented using a database of route information hosted locally on the same call server as the routing policies subcomponent and/or a database residing in a communicatively coupled route database 114 of FIG. 1. Routing policies 320 results in the creation of a route list populated and ordered according to the routing policy invoked.

The route list selection subcomponent 324 provides the capability to retrieve routes from the route list sequentially and is invoked during the Select Route PIC. Routes may be retrieved in the order in which the Route List is created by the routing policies subcomponent 320. In another embodiment, route list selection may support re-ordering of route lists based on the application of policy rules such as load balancing. Route list selection policies can be predefined and/or customer provisioned using a management server 112 (see FIG. 1).

The class of service screening subcomponent 316 is invoked during the Authorize Call Setup PIC, and uses a policy based system to selectively block certain call types originated from specified endpoints in the network. Class of service screening policies may examine the call attributes (and other call context information such as the selected route) to make this decision. Class of service screening policies can be predefined and/or customer provisioned using a management server 112 (see FIG. 1). Class of service screening policies may include called number screening, denied origination and public call blocking.

Called number screening is a form of class of service screening that allows the network administrator or subscriber to create a list of telephone numbers or number ranges that are blocked. This is useful, for example, to block calls to pay-per-call numbers. Denied direct outward dialed public call blocking is a form of class of service screening that allows the network administrator to block calls to the public network while allowing intra-network calls (calls within the enterprise). Denied origination is a form of class of service screening that may block all originating calls from an endpoint. This is useful for endpoints that are set up to only receive calls.

The address formatting subcomponent 332 may be invoked by the terminating agent at the Present Call PIC to manipulate either the original dialed digits or the fully qualified called number into the format (or schema) compatible with the network connected to the terminating endpoint (i.e. gateway). Digit manipulation instructions are provisioned against gateway endpoints in the form of simple removals and/or additions to either the dialed digits or the fully qualified called number. Address digit manipulation is implemented as a signaling policy that may be used in conjunction with other non-translations related signaling policies in accordance with terminating agent signaling subcomponent 328. Address digit manipulation policies can be predefined and/or customer provisioned using a management server 112 (see FIG. 1).

The terminating agent signaling subcomponent 328 is communicatively coupled to the address digit manipulation subcomponent 332. Terminating agent signaling uses address digit manipulation in conjunction with signaling policies specific to the terminating agent type to format information signaled from the terminating gateway endpoint.

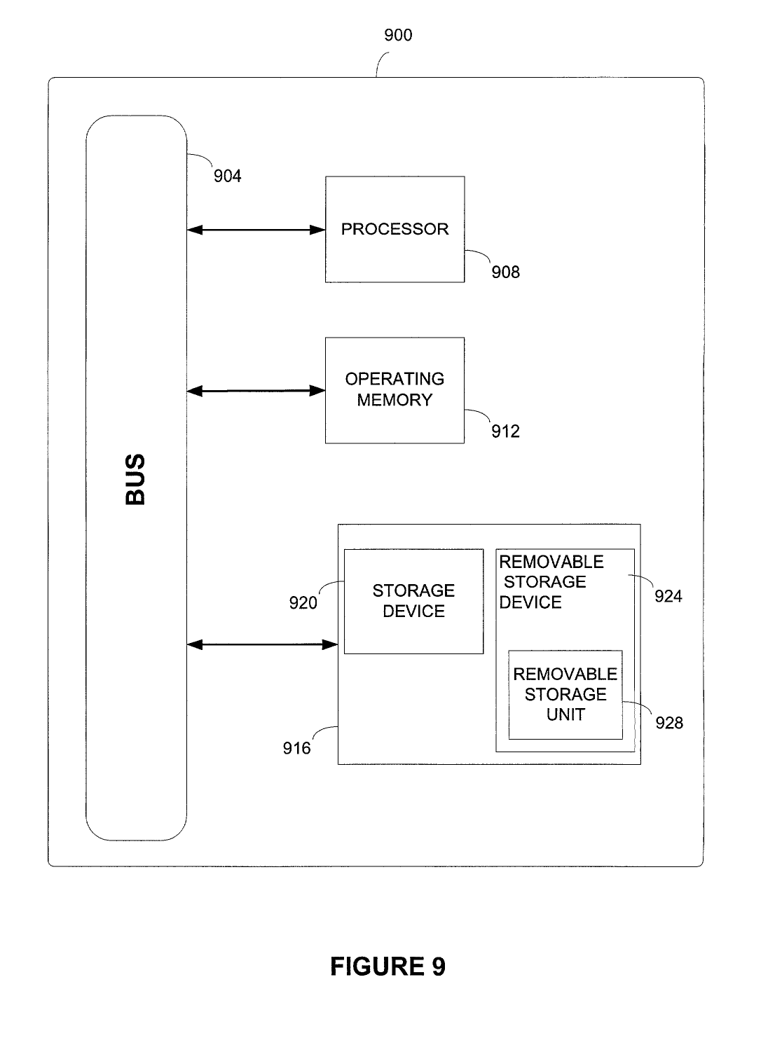

Subcomponents may be communicatively coupled to each other in a manner differing from the exemplary architecture shown in FIG. 3. In cases where function modules are implemented in software code, such signals may include the passing of parameters between those respective functional modules. It should be appreciated by one skilled in the art that functional modules may be implemented using the implementation methods and apparatus of FIG. 9, discussed later in detail.

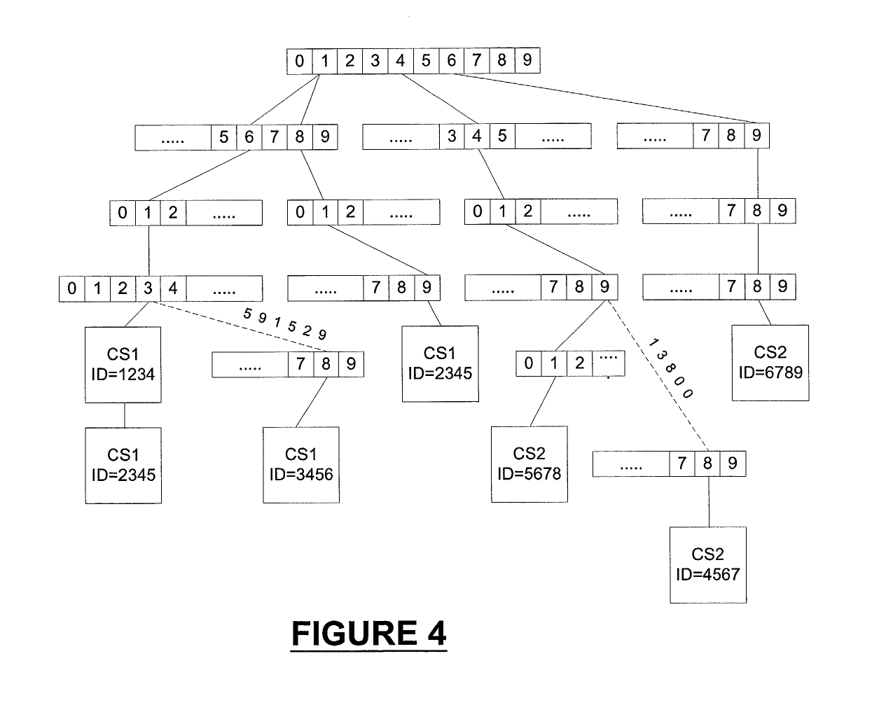

FIG. 4 is a diagram of a public E.164 called number translations configured within the route database. The call servers 104 and 108, optionally in conjunction with a route database 114, of FIG. 1 may index the route database using a fully qualified number to determine the outgoing route. The called number route database is configured by defining per endpoint route characteristics, as depicted in Table 5, which is a representation of the called number route characteristics of endpoints 116, 120, 124, 128, 148 and 152 of FIG. 1. The resulting route database contains references to one or more endpoint routes that are capable of handling a call to a specified called number. The route database may be partitioned to handle translations for multiple number plans, including both public and enterprise (private) number plans.

A number plan range is one or more leading digit followed by a wildcard (i.e. ‘*’). For example, if a route can handle public numbers beginning with a country code (CC) of ‘1’ and a national destination code (NDC) of ‘613’, then the public number range is ‘1613 *’. Similarly, if a route can handle public numbers beginning with a CC of ‘1’, a NDC of ‘613’ and a subscriber number ‘763*’, then the public number range is ‘1613763*’.

A number plan route database may be automatically generated from all of the number plan ranges and fully qualified numbers defined against all of the endpoint routes in the network. Associated with a number plan range is the endpoint route (or routes, if the number plan range is defined against more than one endpoint route) that can handle traffic to those number ranges.

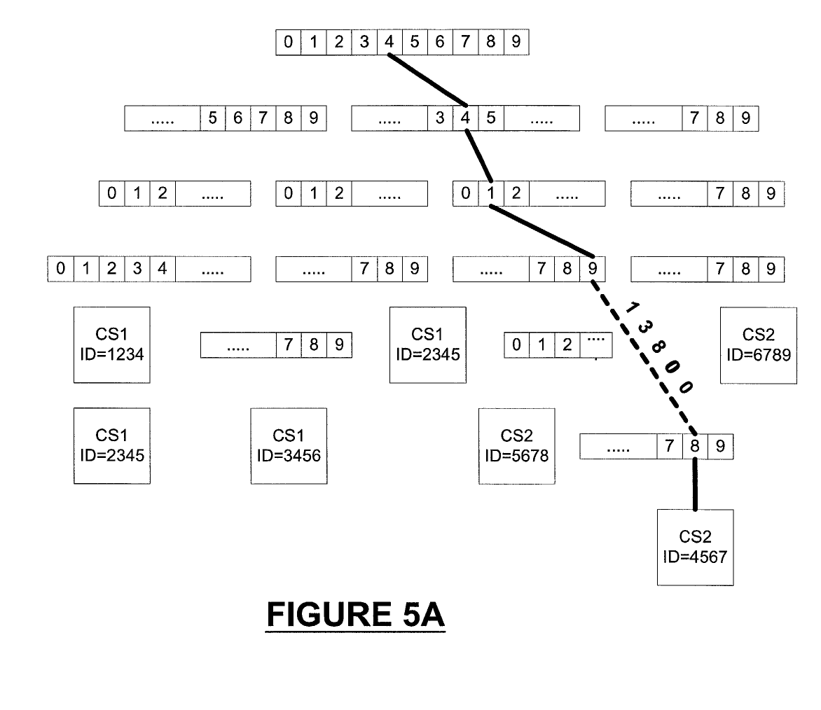

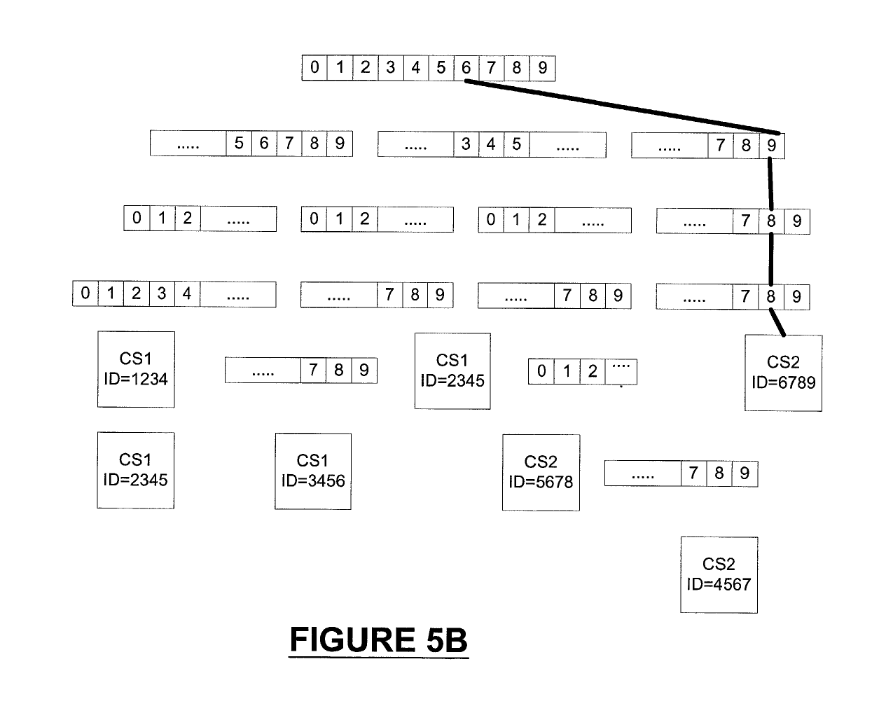

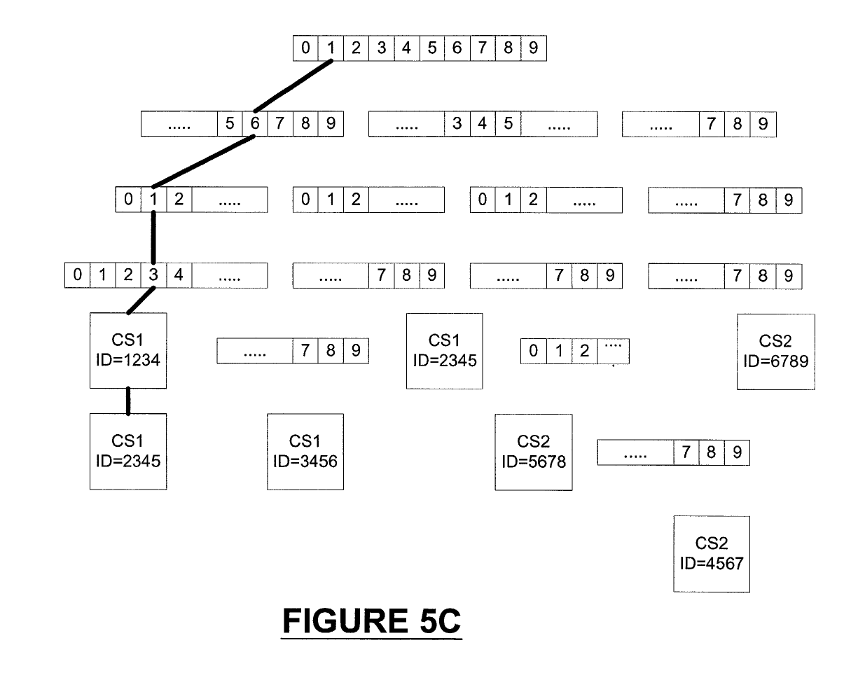

Still referring to FIG. 4, shown is a digit routing tree configured from the public number ranges specified against the endpoints supported by the network shown in FIG. 1 (endpoints 116, 120, 124, 128, 148 and 152 with corresponding route characteristics listed in Table 5). Examples of how exemplary numbers called numbers are mapped to routes are illustrated using FIGS. 5A-5C.

FIG. 5A is a diagram mapping a called number to a call server and endpoint route id per a number plan and a fully qualified number. In the example provided, the called number “44191380008” is mapped to call server CS2 108 (see FIG. 1) and route id 4567. Within call server CS2, the route id 4567 provides a reference to the endpoint 152 (see FIG. 1) associated with the called number.

FIG. 5B shows how an exemplary called number beginning with country code ‘69’ and national destination code ‘88’ is mapped to a call server according to a number plan and a number range (i.e. number range ‘6988*’). In this case, any fully qualified number prefixed by 6988 is served by call server CS2 (108 of FIG. 1) and route id 6789. In this example, CS2 route id 6789 corresponds to gateway GW4 128 (see FIG. 1) which is used to route to public switched telephone network (entity, 144 of FIG. 1) called numbers prefixed with ‘6988’.

FIG. 5C shows a called number beginning with country code ‘1’ and national destination code ‘613’ may be mapped to two endpoint routes according to the number plan and the number range (i.e. number range ‘1613*’). In this example CS1 (104 of FIG. 1) route id 1234 corresponding to gateway GW1 (116 of FIG. 1) and CS1 route id 2345 corresponding to gateway GW2 (136 of FIG. 1) are both possible routes to public switched telephone network (entity, 132 of FIG. 1) called numbers prefixed with ‘1613’. In the event that GW1 is busy, or for the purposes of load balancing, GW2 is used as an alternate route. Table 5 shows the endpoint configuration data, which may be used to build the called number route database. When new endpoints or routes are added to the network, the endpoint route characteristics may be automatically integrated into the route database and may be made accessible to all other network resources (e.g. call servers, route databases, etc.) on the network by the network management system.

It should be noted that number plan range information is one of many route attributes associated with a network device and is not meant to be limited by the described route attributes. Examples of other route attributes include service provider, service type (such as operator service or directory assistance), bearer capability and signaling protocol. These attributes are also used in the automatic creation of route references in the routing database.

The management system used to provision endpoints and routes exposes a minimum subset of the configurable aspects of the architecture while hiding much of the detail and automating the complex task of managing translations data. This provides the advantage of significantly lower administration costs when compared to existing circuit switched translations architectures.

In addition to or in place of a manual provisioning interface used by a network administrator to input routing attributes, certain network devices and endpoints may be capable of transmitting their routing attributes to the management system for inclusion in the routing database using an auto discovery and configuration mechanism. This capability facilitates dynamic configuration of the routing database as endpoints become active on the network, and eliminates manual effort associated with adding new route references into the routing database. Another mechanism for determining routing attributes of a network device involves transmitting a routing attribute request, the routing attribute request being destined for a network device. Responsive to the routing attribute request, receiving a routing attribute response from the network device, the response comprising at least one routing attribute the network device is adapted to process. Next, a signal is transmitted comprising the at least one routing attribute the network device is adapted to process. The information in this signal may then be used to configure the route database with routing attribute information.

Endpoint configuration data, which may be used to build the translations database, is shown in TABLE 5 below.

TABLE 5

| | Number Plan / Number | Call | |
|---|---|---|---|
| Endpoint Name | Plan Ranges routed to | Server Host | Route ID |
| GW1 | E.164/1613* | CS1 | 1234 |
| GW2 | E.164/1613*, 1819* | CS1 | 2345 |
| 16135915298 | E.164/16135915298 | CS1 | 3456 |
| 44191380008 | E.164/44191380008 | CS2 | 4567 |
| GW3 | E.164/44181* | CS2 | 5678 |
| GW4 | E.164/6988* | CS2 | 6789 |

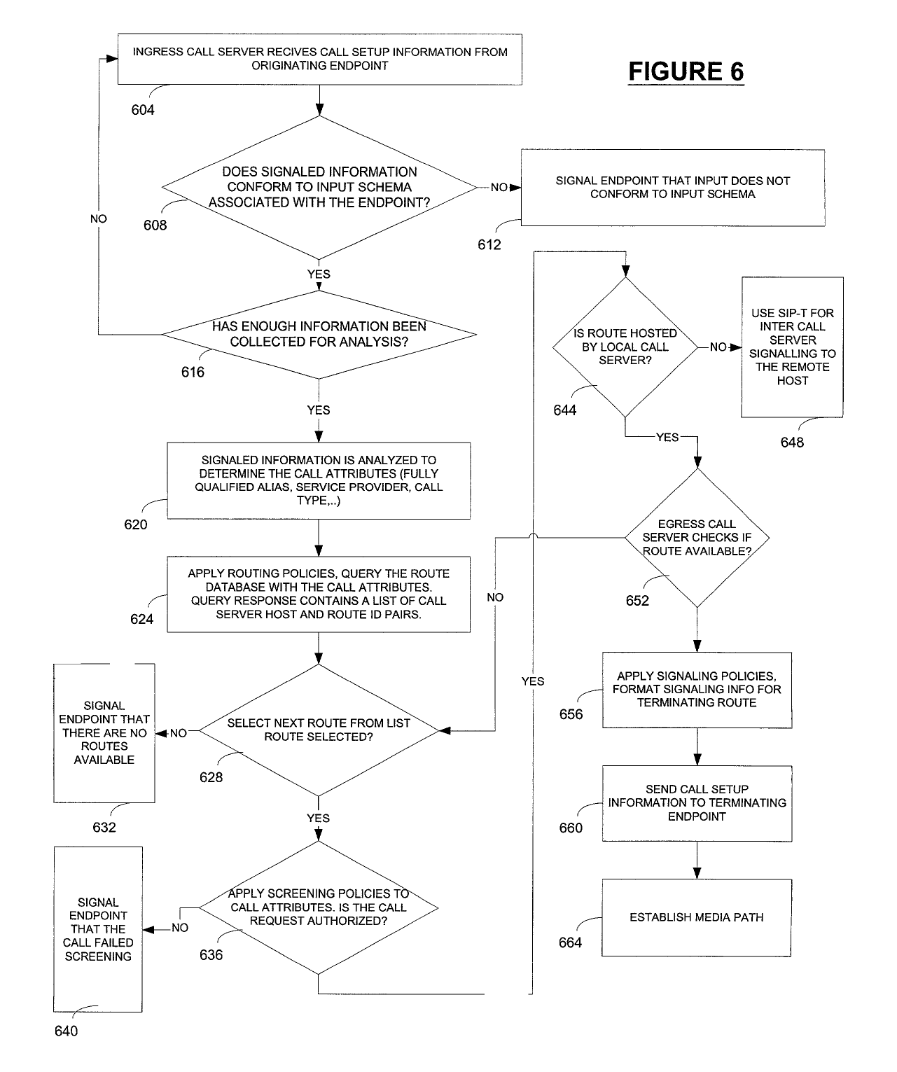

Consider now how a call is handled, with reference to the flowchart as illustrated in FIG. 6. An ingress call server receives call setup information from an originating endpoint (step 604). In this embodiment, the information comprises dialed digits. Next, the dialed digits are analyzed to ensure they conform to a dial-plan schema (608). If they do not conform, then a signal is sent to the originating endpoint that the digits do not conform to the dial-plan schema (step 612). If more information is required, the call server waits for additional digits from the endpoint (616). If the information is complete, the digits are analyzed and the call attributes are determined (i.e. fully qualified number, call type, preferred service provider)(step 620). Next routing policies are applied and the route database queried with the call attributes. A route list of call server host and route id pairs is returned in response to the query (624). Note the route database may be local to the ingress call server, on a route database or distributed between both. A route is selected from the list (628). If there are no routes in the list, the endpoint is signaled that there are no routes available (632). If there is a route selected from the list, class of service screening policies are applied (636). If the call is not authorized, the endpoint is signaled that the call failed screening (640). If the selected route is not hosted by the ingress call server (644), SIP-T inter call server signaling is used to contact the remote host (648). If the route is not available, the next route in the route list is selected (652). If the route is available, signaling policies are invoked to format the terminating call setup information (654). The call setup is sent to the terminating endpoint (658). Once the terminating endpoint answers the call, a media path is established between it and the originating endpoint (664).

In another embodiment, the input information received from the originating endpoint may include a person's name in an abbreviated text format (604), perhaps from an access device using voice recognition technology. The information is verified to be syntactically correct and complete (608 and 616). The name is fully qualified by consulting a directory server and the call attributes determined (620). The routing policy queries a route database which in this embodiment is configured with a mapping of subscriber names to call server host and route id (624). Routes are selected and steps 628 through 644 occur as described in the first embodiment.

Many other embodiments exist for other forms of input information such as, web page URL (Universal Resource Locator), e-mail address, common name, or any other unique identifier associated with the called party.

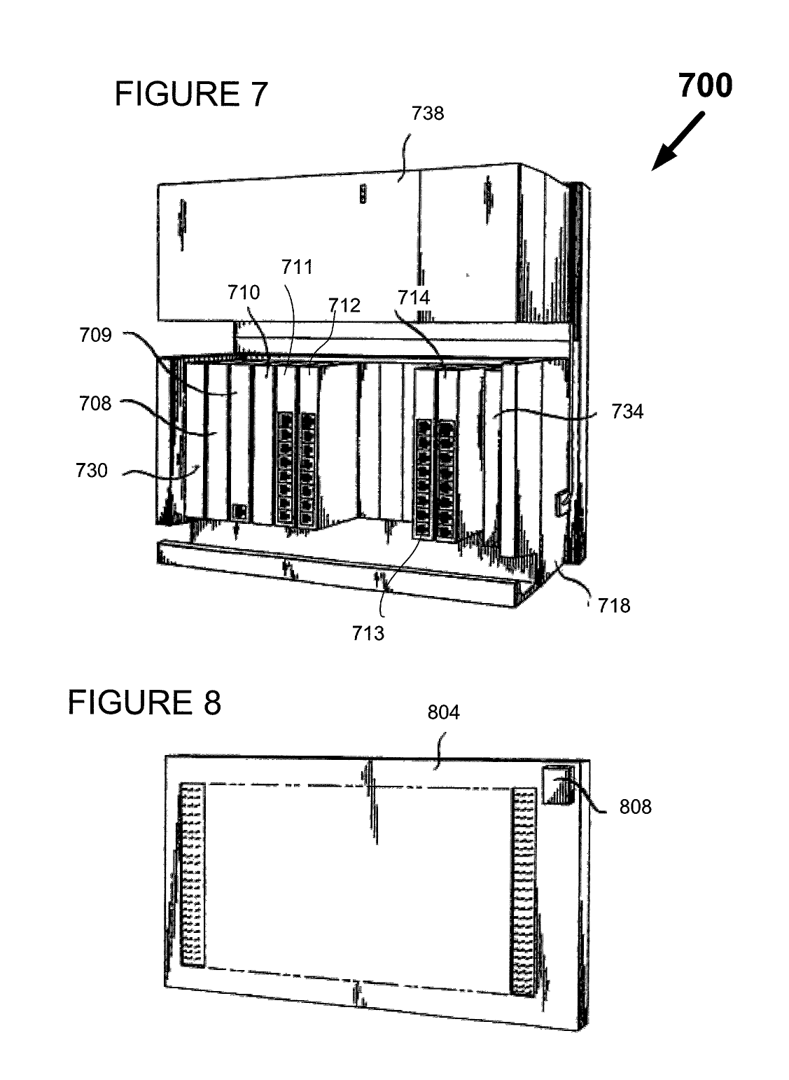

A front view of remote module 700 is illustrated in FIG. 7 and a back view is illustrated in FIG. 8. As illustrated in FIG. 7, remote module 700 comprises printed circuit boards 708 through 714, which are physically mounted in board carrier 718. These boards plug into backplane 804, as illustrated in FIG. 8, which is attached to board carrier 718. The boards illustrated in FIG. 7 have a processor for executing initial diagnostics on the circuits of that board and also for reporting the diagnostics of that board to the remote diagnostics processor 726, which is physically mounted on remote diagnostics processor board 730.

In addition, as illustrated in FIG. 8, backplane 804 has a backplane processor 808. Backplane processor 808 responsively provides information denoting the backplane type of backplane 804, the number of boards plugged into backplane 804, and the location of each board.

Power board 734 provides the power to the boards plugged into backplane 804. Power supply 738 supplies power to power board 734. Communications fabric interface board 712 interfaces the devices coupled to backplane 804 to a communications fabric. Communications fabric can be a variety of different types of communications technology, i.e. optical technology for broadband communications, wireless technology for wireless communications, etc. to allow operability of the present invention regardless of communications transport medium.

FIG. 9 is a computer system 900 programmed for executing a computer program according to various embodiments of the invention. Each network resource may be implemented on a computer system, over a distributed system, or may be combined with one of the aforesaid network resources. Computer system 900 may be implemented on a printed circuit board as shown by boards 708 through 714 (see FIG. 7), coupled to backplane 804 so that signals from the board may be communicated across the backplane to communicate with other network resources and/or boards.

The computer system 900 has one or more processors, such as processor 908. The processor is communicatively coupled to a bus 904. Bus 904 may be connected or communicatively coupled via a backplane interface to the backplane 804 of FIG. 7.

The computer system 900 also includes operating memory 912. A suitable operating memory 912 has a random access memory (RAM), and a storage memory 916.

The storage memory 916 includes, for example, a storage device 920 and/or a removable storage device 924, representing a floppy disk drive, magnetic tape drive, a compact disc drive, digital versatile disc drive, flash memory drive, etc. The removable storage media 928 is the media used with removable storage device 924. As will be appreciated by those skilled in the art, the storage devices include a computer-useable storage medium having stored therein application software and/or data. Such software and/or data may be loaded from a server onto a storage device.

Computer programs are stored in operating memory 912 and/or in storage device 916. Such computer programs, when executed, enable the computer system 900 to perform the features of the present invention as discussed herein. In particular, the computer programs, when executed, enable the processor 908 to perform the features of the present invention. Accordingly, such computer programs represent controllers of the computer system 900.

In another embodiment, the present invention is directed to a computer program product comprising a computer readable medium having control logic (computer software) stored therein. The control logic, when executed by the processor 908, causes the processor 908 to perform the functions of the invention as described herein.

In yet another embodiment, the present invention is implemented in hardware using, for example, a hardware state machine. Such a hardware state machine circuitry may be implemented, for example, using dedicated logic circuitry, field programmable gate arrays (FPGA), programmable gate arrays (PGA), application specific integrated circuits (ASIC), read only memory (ROM), electrically erasable programmable read only memory (EEPROM), erasable programmable read only memory (EPROM), or any combination or variant thereof. Implementation of the hardware state machine so as to perform the functions described herein will be apparent to persons skilled in the art to which the present invention pertains.

A network translations method and apparatus has been described to more effectively implement translations subsystems for telephony communications while providing reduced network management administrative overhead.

While the invention has been disclosed with respect to a limited number of embodiments, those skilled in the art will appreciate numerous modifications and variations therefrom. It is intended that the appended claims cover all such modifications and variations as fall within the true spirit and scope of the invention.

What is claimed is:

1. A method of telephony translations and route selection comprising:
receiving a call request, the call request comprising input information being for a telephony call;
determining at least one call attribute from the input information;
transmitting a routing policy request to query a route database;
responsive to the routing policy request, receiving a routing policy response, the response comprising at least one routing parameter; and
using the at least one routing parameter to influence call set up.

2. The method as claimed in claim 1, wherein the at least one routing parameter comprises a preferred route.

3. The method as claimed in claim 2, wherein the at least one routing parameter further comprises an alternate route.

4. The method as claimed in claim 1, wherein the input information comprises a called alias.

5. The method as claimed in claim 4, wherein the called alias is a telephone number.

6. The method as claimed in claim 5, wherein the telephone number is qualified to conform to a numbering plan.

7. The method as claimed in claim 6, wherein the numbering plan conforms to the ITU-T E.164 standard.

8. The method as claimed in claim 4, wherein the called alias is a Uniform Resource Locator (URL).

9. The method as claimed in claim 4, wherein the called alias is an alphanumeric alias associated with a telephony device.

10. The method as claimed in claim 1, wherein the routing policy response selects a route from the route database according to the at least one call attribute

11. The method as claimed in claim 1, wherein a routing policy accesses the route database for alias to endpoint mapping data.

12. The method as claimed in claim 1, wherein the input information originates from one of a calling endpoint device, a network operator device and an interactive voice response unit.

13. An apparatus for route selection in a communications network, comprising:
a controller adapted to derive at least one call attribute from a call request for a telephony transmission; and
a route database communicatively coupled to said controller, said route database being adapted to receive a routing policy request from said controller, and transmit a routing policy response having at least one routing parameter, said routing policy response generated responsive to a routing policy request based on the at least one call attribute.

14. The apparatus of claim 13, further comprising a controller adapted to use the at least one routing parameter to influence call set up.

15. The apparatus as claimed in claim 13, wherein the at least one routing parameter comprises a preferred route.

16. The apparatus as claimed in claim 15, wherein the at least one routing parameter further comprises an alternate route.

17. The apparatus as claimed in claim 13, wherein the at least one call attribute comprises a called alias.

18. The apparatus as claimed in claim 17, wherein the called alias is a telephone number.

19. The apparatus as claimed in claim 18, wherein the telephone number is qualified to conform to a numbering plan.

20. The apparatus as claimed in claim 17, wherein the called alias is a Uniform Resource Locator (URL).

21. The apparatus as claimed in claim 17, wherein the called alias is an alphanumeric alias associated with a telephony device.

22. The apparatus as claimed in claim 13, wherein the routing policy response selects a route from the route database according to the at least one call attribute.

23. The apparatus as claimed in claim 13, wherein the routing policy accesses a route database to provide alias to endpoint mapping data.

24. An apparatus for route selection in a communications network, comprising:
means for receiving a call request, the call request being for a telephony call;
means for deriving at least one call attribute from the call request;
means for transmitting a routing policy query request to a route database, the routing policy request based on the at least one call attribute;
means for receiving a routing policy response from a route database, the routing policy response comprising at least one routing parameter; and
means for utilizing the at least one routing parameter to influence control of call set up.

25. A system for call setup over a communications network, the system comprising:
(a) an ingress call server having a receiver for receiving a call request for a telephony call, the call request comprising alias information for the telephony call; the ingress call server comprising:
a controller adapted to derive at least one call attribute from the call request; and
a transmitter for transmitting a routing policy query request comprising the at least one call attribute, and
(b) a route database communicatively coupled to the ingress call server, the route database comprising:
a receiver for receiving a routing policy query request;
a controller adapted to translate the at least one call attribute to endpoint routing information; and
a transmitter for transmitting a routing policy query response comprising the endpoint routing information.

26. A system for call setup of claim 25, further comprising:
an egress call server comprising a receiver to receive a call server transfer signal from the ingress call server, the call server transfer signal defining call server transfer instructions from the ingress call server to the egress call server.

27. An article including one or more machine-readable storage media containing instructions to manage communications apparatus in a communications network, the instructions when executed causing a controller to:
receive a call request, the call request being for a telephony call;
derive at least one call attribute from the call request;
transmit a routing policy query request to a routing policy server, the routing policy request defining the at least one call attribute;
receive a routing policy response from the routing policy server, the routing policy response comprising at least one routing parameter; and
transmit the at least one routing parameter to influence control of call set up.
